(19) United States
(12) Patent Application Publication
(10) Pub. No.: US 2011/0223560 A1
(43) Pub. Date: Sep. 15, 2011

(54) METHOD OF STORING AND REUSING HARD TISSUE OF TEETH

(76) Inventor: Gi Won SUNG, Seoul (KR)

(21) Appl. No.: 13/043,943

(22) Filed: Mar. 9, 2011

(30) Foreign Application Priority Data
Mar. 10, 2010 (KR) 10-2010-0021230

(51) Int. Cl. A61C 8/00

(52) U.S. Cl. 433/173

(57) ABSTRACT

A method of storing and reusing hard tissue of a tooth. The method includes low-speed freezing and storing the hard tissue of the tooth; low-speed thawing the frozen hard tissue when the stored hard tissue is to be reused; and reusing the hard tissue. Accordingly, the hard tissue of the tooth is barely damaged, and a color thereof is hardly changed in comparison with the tooth before freezing.

### CROSS-REFERENCE TO RELATED PATENT APPLICATION

This application claims the benefit of Korean Patent Application No. 10-2010-0021230, filed on Mar. 10, 2010, in the Korean Intellectual Property Office, the disclosure of which is incorporated herein in its entirety by reference.

### BACKGROUND OF THE INVENTION

1. Field of the Invention

The present invention relates to a method of storing and reusing teeth, and more particularly, to a method of effectively storing and reusing discarded teeth.

2. Description of the Related Art

While life quality of the elderly in an aging society in which the number of senior citizens are rapidly increasing is a social issue, the importance of dental health also needs attention. Furthermore, if an apparatus for reapplying a healthy body requirement to a subject in elderly days can be supported in a biotechnological field, the aging society will psychologically and emotionally reach a high quality state in terms of dental treatment. As a method of increasing quality in terms of medical care, if a tooth of a subject, which was healthy but had to be extracted due to some reason, can be reused through autogeneous tooth transplantation when the subject becomes an old person after storing the teeth in a teeth bank for 10 to 20 years, the life quality of the elderly in the aging society in which the number of senior citizens are rapidly increasing may be improved.

Autogeneous tooth transplantation means that an impacted tooth, a malposed tooth, a non-functional tooth, or a traumatic deciduous tooth is transplanted to a desired position. Clinical evaluations of autogeneous tooth transplantation have been objectively proven and the autogeneous tooth transplantation is an operation skill involving focusing a biological reproductive ability of a periodontal membrane. As a result, successful autogeneous tooth transplantation in which a physiological structure, such as periodontal ligament tissue, is reproduced may construct teeth supporting tissue that is similar to natural teeth. An autogeneous tooth transplantation operation process includes taking a panoramic picture of a part of wisdom teeth to be transplanted, making the same teeth by a using a 3D process, and transplanting the teeth to replace the extracted part.

The autogeneous tooth transplantation operation described above does not have any severe problem in terms of maintaining and storing the extracted teeth since the teeth are extracted and transplanted at almost the same time. However, when autogeneous teeth, which were extracted when a patient was young, are stored in the teeth bank or when autogeneous teeth are stored in the teeth bank for a long while, autogeneous teeth tissue must be stored without destruction of tissue cells, a change in hardness of the teeth, or a change in color of the teeth until the autogeneous teeth are transplanted.

In addition, tissue forming a tooth includes cementum, soft tissue such as a periodontal ligament, enamel, and hard tissue such as dentin. However, conventional technologies for autogeneous tooth transplantation mainly relate to storing soft tissue, particularly periodontal ligament (PDL) cells, and maintaining activity pertaining to the storage.

### SUMMARY OF THE INVENTION

The present invention provides a method of storing and reusing hard tissue forming a tooth without a change in hardness or color for autogeneous tooth transplantation.

According to an aspect of the present invention, there is provided a method of storing and reusing hard tissue of a tooth, the method including low-speed freezing and storing the hard tissue of the tooth; low-speed thawing the frozen hard tissue when the stored hard tissue is reused; and reusing the hard tissue.

The low-speed freezing may further include keeping the hard tissue cold at 2° C. to 3° C.; and keeping the hard tissue frozen at −6° C. to −7° C.

The low-speed thawing may further include thawing the frozen hard tissue in a cold room of 2° C. to 3° C.; and thawing the thawed hard tissue at room temperature again.

The reusing may further include inserting the low-speed thawed hard tissue of the tooth into an insertion space prepared in an artificial prosthesis including an artificial tooth.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional diagram of a tooth;

FIG. 2 is an electron microscope picture of a tooth before freezing to be compared with teeth that were experimented on in various freezing and thawing methods, according to an exemplary embodiment of the present invention;

FIGS. 3A and 3B are a result graph and an electron microscope picture of a color change experiment performed on teeth that were high-speed thawed after high-speed freezing;

FIGS. 4A and 4B are a result graph and an electron microscope picture of a color change experiment performed on teeth that were low-speed thawed after high-speed freezing;

FIGS. 5A and 5B are a result graph and an electron microscope picture of a color change experiment performed on teeth that were high-speed thawed after low-speed freezing; and

FIGS. 6A and 6B are a result graph and an electron microscope picture of a color change experiment performed on teeth that were low-speed thawed after low-speed freezing.

### DETAILED DESCRIPTION OF THE INVENTION

The present invention will now be described more fully with reference to the accompanying drawings, in which exemplary embodiments of the invention are shown. In the following description, only parts necessary to understand operations according to the present invention are described while other parts may not be described so as not to obscure the point of the present invention.

The terminology or words used in the specification and claims described below should not be analyzed according to their common or lexical meaning but should be analyzed according to the meaning and concept conforming to the technical spirit of the present invention to most properly represent the present invention.

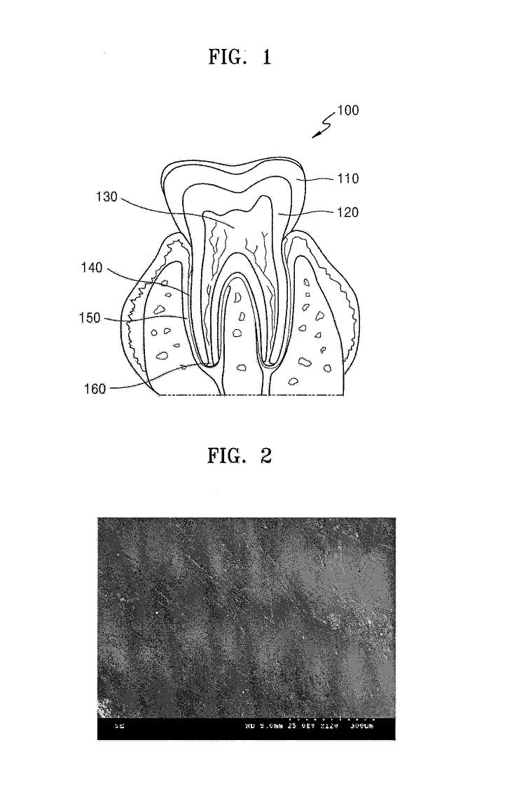

FIG. 1 is a cross-sectional diagram of a tooth. Referring to FIG. 1, the tooth includes enamel 110, dentin 120, tooth pulp 130, cementum 140, a periodontal ligament 150, and a root end opening 160. In autogeneous tooth transplantation, it is very important that hard tissue, such as the enamel 110 and the dentin 120, and soft tissue, such as the cementum 140 and the periodontal ligament 150, be stored and reused.

The enamel 110 is a hard substance covering a tooth and protecting the dentin 120. The enamel 110 is made of apatite crystals mainly including calcium and phosphoric acid, and since the thickness and density of the enamel 110 vary according to the surface of a tooth, an edge part of the tooth for chewing is hardest. The dentin 120 is yellow tissue forming material of the tooth, is harder than bones and softer than the enamel 110, and is made of apatite crystals mainly including calcium and phosphoric acid.

The tooth pulp 130 may be called pulp, and nerve cells of the tooth exist in the tooth pulp 130. The cementum 140 covers a tooth root and a portion of the other parts. The cementum 140 has a yellow color and is softer than the enamel 110 or the dentin 120. The periodontal ligament 150 is called a PDL cell or a periodontal membrane, and since this cell is a cell around a tooth root, which determines whether treatment of a tooth transplanted is successful, and an important cell for preventing the tooth root from absorbing water and for suppressing adhesion, the periodontal ligament 150 is a cell significantly affecting when a tooth is extracted and transplanted and after a tooth is treated.

Since the periodontal ligament 150, i.e., the PDL cell, is an important element in the tooth tissues when the tooth is transplanted or replanted, many prior arts related to the periodontal ligament 150 exist. However, there has not been much research conducted into storing and reusing the hard tissue such as the enamel 110 and the dentin 120. Thus, an embodiment of the present invention provides a method of storing and reusing hard tissue of a tooth without a change in hardness or color.

In an embodiment of the present invention, a comparison of a freezing or refrigerating method considered as a method of storing hard tissue with a method of thawing a frozen or refrigerated tooth when stored teeth are reused, is mainly described.

In an embodiment of the present invention, teeth are sampled through an embedding process, wherein materials obtained by processing roots and nerves are sampled by classifying them into premolars and molars, and are used by hardening each of the teeth in a small plastic container with around 3 mm of epoxy resin on a pipette. Each hardened sampled tooth is ground so that a surface to be experimented on is exposed. Here, the tooth is ground by an auto polish motor. In this case, the tooth is ground by applying a force in a grinding direction of the auto polish motor. The sampled teeth must be ground so that the bottom of each tooth is maintained level. Each tooth is correctly measured by using a level.

Through various freezing and thawing methods, hardness of a tooth surface of each of the sampled teeth is measured by using a micro Vickers hardness tester, and a color change thereof is measured by using a spectrophotometer. For objective and correct measurement, not only spectral luminous intensity but also chrominance and chromaticity are measured and compared for the sampled teeth according to regulations of the Commission Internationale de l'Eclairage (CIE).

In an embodiment of the present invention, a freezing method is largely achieved by high-speed freezing and low-speed freezing, wherein the high-speed freezing is achieved by putting teeth in liquid nitrogen and storing the teeth at −196° C. and the low-speed freezing is achieved by putting teeth in a cold room at 2° C. to 3° C. for first two hours and storing the teeth in a freezing room at −6° C. to −7° C. for a week.

In an embodiment of the present invention, a thawing method is largely achieved by high-speed thawing and low-speed thawing, wherein the high-speed thawing is achieved by thawing teeth in a dryer at 37° C. for 4 hours immediately after pulling the teeth out of a freezing container. In the case of the high-speed freezing, the low-speed thawing is achieved by thawing the teeth in the freezing room for 2 hours immediately after pulling the teeth out of the liquid nitrogen, thawing the teeth in the cold room for 2 hours, and thawing the teeth at the room temperature for 2 hours. In the case of the low-speed freezing, the low-speed thawing is achieved by thawing the teeth in the cold room for 2 hours immediately after pulling the teeth out of the freezing room and further thawing the teeth at the room temperature for 2 hours.

In an embodiment of the present invention, through experiments of 4 groups, i.e., low-speed freezing—low-speed thawing, low-speed freezing—high-speed thawing, high-speed freezing—high-speed thawing, and high-speed freezing—low-speed thawing, performed by combining freezing methods including the high-speed freezing and the low-speed freezing and thawing methods including the high-speed thawing and the low-speed thawing, an optimal method of storing and reusing hard tissue of a tooth is derived.

1. High-Speed Freezing—High-Speed Thawing

Table 1 indicates hardness data measured before the high-speed freezing, and Table 2 indicates a result measured after thawing hard tissues of sampled teeth, which were stored in liquid nitrogen at −196° C., in a dryer at 37° C. for 4 hours immediately after pulling the teeth out of a freezing container. In a test process using the micro Vickers hardness tester, measurement is performed with a weight of 300 g for 10 seconds more than 5 times, and an average value is calculated. A color change is measured by using the spectrophotometer.

TABLE 1

| | data | | | | | |
|---|---|---|---|---|---|---|
| Sample | 1st | 2nd | 3rd | 4th | 5th | average |
| S1(premolar) | 357.9 | 353.7 | 314.5 | 355.1 | 335.1 | 343.26 |
| S2 | 370.9 | 387.8 | 379.7 | 322.7 | 345.1 | 361.24 |
| S3 | 409.2 | 409.2 | 370.9 | 400.8 | 404.2 | 398.86 |
| S4 | 390.9 | 378.4 | 360.7 | 384.4 | 390.9 | 381.06 |
| S5 | 387.8 | 360.7 | 355.1 | 365.0 | 386.2 | 370.96 |
| L1(molar) | 375.4 | 379.9 | 372.4 | 389.3 | 399.1 | 383.22 |
| L2 | 414.4 | 404.1 | 387.8 | 387.8 | 379.9 | 394.8 |
| L3 | 284.4 | 288.4 | 164.8 | 472.5 | 440.1 | 330.04 |
| L4 | 378.4 | 404.1 | 392.6 | 397.4 | 390.9 | 392.68 |
| L5 | 409.2 | 355.1 | 355.1 | 355.1 | 409.2 | 376.74 |

TABLE 2

| | data | | | | | |
|---|---|---|---|---|---|---|
| Sample | 1st | 2nd | 3rd | 4th | 5th | average |
| L1(molar) | 330.9 | 325.4 | 350.9 | 343.8 | 353.0 | 340.8 |
| L2 | 365.8 | 380.4 | 381.5 | 360.1 | 368.7 | 371.38 |
| L3 | 383.1 | 360.1 | 380.5 | 375.4 | 351.0 | 370.04 |
| L4 | 371.5 | 390.4 | 392.0 | 365.4 | 370.5 | 377.96 |
| L5 | 334.2 | 350.4 | 365.2 | 330.5 | 360.8 | 348.22 |
| S1(premolar) | 413.0 | 410.6 | 399.3 | 372.4 | 400.5 | 399.16 |
| S2 | 333.3 | 360.3 | 350.4 | 325.4 | 330.0 | 339.88 |
| S3 | 456.3 | 405.5 | 390.4 | 400.5 | 375.5 | 405.64 |
| S4 | 436.5 | 369.2 | 350.4 | 370.1 | 355.9 | 376.42 |
| S5 | 351.2 | 350.6 | 368.9 | 401.2 | 373.5 | 369.08 |

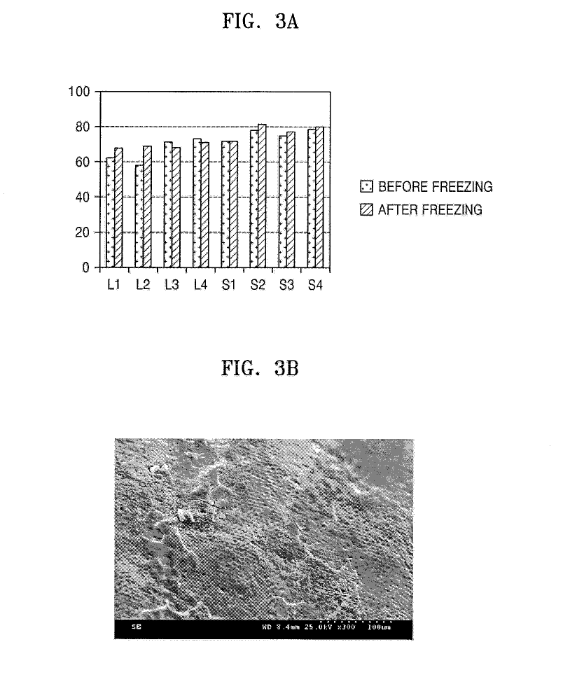

The results of Table 2 indicate that hardness is barely changed even after the high-speed freezing and the high-speed thawing in comparison with Table 1 of before the freezing. FIG. 3A shows a color change comparison graph before and after freezing of teeth that were high-speed thawed after high-speed freezing. As shown in FIG. 3A, the color change experiments performed on premolars and molars show a result that there is barely different between one-week freezing results. The graph shown in FIG. 3A shows the fact that the change is not that severe.

However, referring to FIG. 3B showing an electron microscope picture of a tooth high-speed thawed after high-speed freezing, the tooth high-speed thawed after high-speed freezing has severe cracks and damaged tissues in comparison with the control group shown in FIG. 2.

2. High-Speed Freezing—Low-Speed Thawing

Table 3 indicates hardness data measured before the high-speed freezing, and Table 4 indicates measurement results obtained after thawing hard tissues of sampled teeth, which were stored in liquid nitrogen at −196° C., in the freezing room for 2 hours immediately after pulling the teeth out of the liquid nitrogen, thawing the teeth in the cold room for 2 hours, and thawing the teeth at room temperature for 2 hours. The measurement of hardness and color change is the same as described above.

TABLE 3

| | data | | | | | |
|---|---|---|---|---|---|---|
| Sample | 1st | 2nd | 3rd | 4th | 5th | average |
| L6 | 354.3 | 396.8 | 378.4 | 366.6 | 374.3 | 374.16 |
| L7 | 330 | 351.8 | 377.7 | 360.5 | 359.9 | 355.98 |
| L8 | 401.7 | 397.4 | 353.3 | 352.6 | 379 | 376.8 |
| S6 | 361.1 | 364 | 346.7 | 362.2 | 325.5 | 351.9 |
| S7 | 371.4 | 323 | 330.7 | 349.1 | 353.2 | 345.48 |

TABLE 4

| | data | | | | | |
|---|---|---|---|---|---|---|
| Sample | 1st | 2nd | 3rd | 4th | 5th | average |
| L6 | 354.4 | 388.5 | 403.9 | 385.4 | 377.4 | 382.92 |
| L7 | 359.8 | 377 | 341.9 | 398.9 | 388.1 | 373.14 |
| L8 | 364.5 | 399.2 | 325.8 | 359.4 | 387.4 | 367.26 |
| S6 | 324.8 | 349.2 | 350.2 | 378.2 | 320.1 | 344.5 |
| S7 | 344.5 | 367.8 | 312.5 | 340.7 | 355.9 | 344.28 |

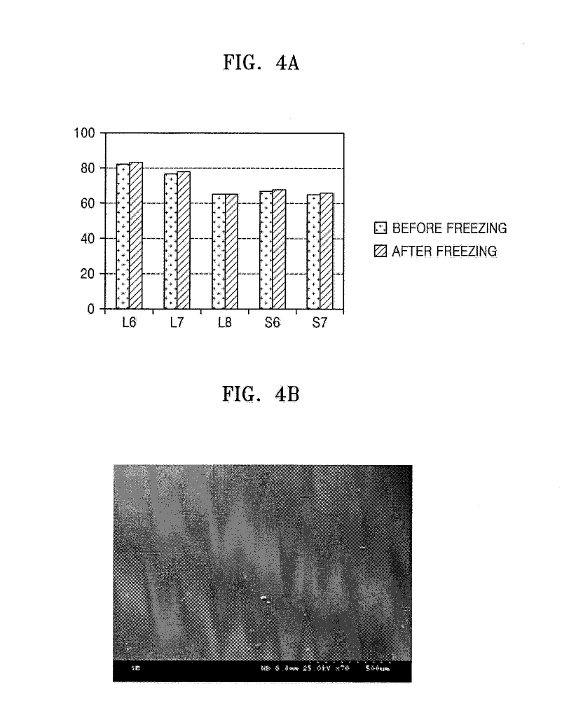

The results of Table 4 indicate that hardness is barely changed even after the high-speed freezing and the low-speed thawing in comparison with Table 3 of before the freezing. FIG. 4A shows a color change comparison graph before and after freezing of teeth low-speed thawed after high-speed freezing. As shown in FIG. 4A, chromaticity of the teeth is barely changed to be said that it is not changed at all.

However, referring to FIG. 4B showing an electron microscope picture of a tooth low-speed thawed after high-speed freezing, the tooth low-speed thawed after high-speed freezing has a little cracks even though the cracks are much reduced in comparison with the tooth high-speed thawed after high-speed freezing, which is shown in FIG. 3B.

3. Low-Speed Freezing—High-Speed Thawing

Table 5 indicates hardness data measured before the low-speed freezing, and Table 6 indicates measurement results obtained after thawing hard tissues of sampled teeth, which were put in the cold room at 2° C. to 3° C. for first two hours and stored in the freezing room at −6° C. to −7° C. for a week, in a dryer of 37° C. for 4 hours immediately after pulling the teeth out of the freezing room. The measurement of hardness and color change is the same as described above.

TABLE 5

| | data | | | | | |
|---|---|---|---|---|---|---|
| Sample | 1st | 2nd | 3rd | 4th | 5th | average |
| L4 | 399.1 | 366.6 | 385.3 | 393.5 | 365.8 | 382.06 |
| L5 | 341.7 | 360.2 | 353 | 379.3 | 358.4 | 358.52 |
| S3 | 312.4 | 329.3 | 323 | 316.9 | 330.1 | 322.34 |
| S4 | 367.6 | 398.2 | 365.8 | 372.4 | 375.5 | 375.9 |
| S5 | 383.2 | 351.2 | 385.3 | 367.6 | 350.5 | 367.56 |

TABLE 6

| | data | | | | | |
|---|---|---|---|---|---|---|
| Sample | 1st | 2nd | 3rd | 4th | 5th | average |
| L4 | 365.9 | 378.4 | 344.5 | 386.5 | 378.4 | 370.74 |
| L5 | 375.5 | 347.1 | 358.5 | 367.4 | 369 | 362.9 |
| S3 | 362.5 | 342.2 | 351.2 | 341.2 | 351.2 | 349.66 |
| S4 | 358.4 | 354.1 | 362.4 | 318.7 | 365.4 | 351.8 |
| S5 | 372 | 345.8 | 327.2 | 362.5 | 347.2 | 350.94 |

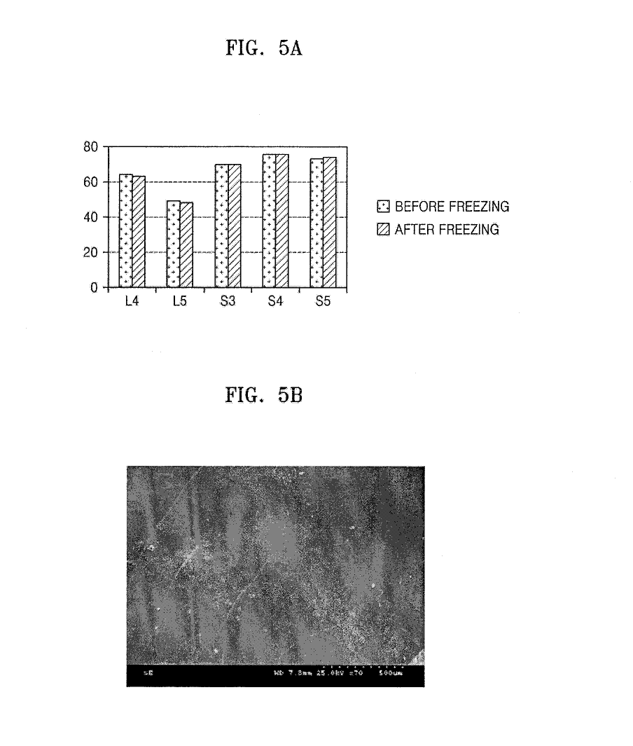

Hardness of the teeth high-speed thawed after the low-speed freezing is barely changed. In addition, a color change comparison graph shown in FIG. 5A shows that a color change barely occurs.

However, referring to FIG. 5B, there are visible cracks according to a result of the high-speed thawing even though low-speed freezing has been performed.

4. Low-Speed Freezing—Low-Speed Thawing

Table 7 indicates hardness data measured before the low-speed freezing, and Table 8 indicates measurement results obtained after thawing hard tissues of sampled teeth, which were put in the cold room at 2° C. to 3° C. for the first two hours and stored in the freezing room at −6° C. to −7° C. for a week, in the cold room for 2 hours immediately after pulling the teeth out of the freezing room, and thawing the teeth at the room temperature for 2 hours. The measurement of hardness and color change is the same as described above.

TABLE 7

| | data | | | | | |
|---|---|---|---|---|---|---|
| Sample | 1st | 2nd | 3rd | 4th | 5th | average |
| L1 | 375.4 | 352.6 | 376.7 | 371.5 | 363.9 | 368.02 |
| L2 | 395.6 | 369.5 | 351.2 | 406.4 | 354.2 | 375.38 |
| L3 | 342.5 | 349.4 | 353.9 | 389.6 | 369.5 | 360.98 |
| S1 | 342.5 | 356.6 | 349.4 | 362 | 360.2 | 354.14 |
| S2 | 323 | 337.5 | 359.3 | 339.2 | 335.8 | 338.96 |

TABLE 8

| | data | | | | | |
|---|---|---|---|---|---|---|
| Sample | 1st | 2nd | 3rd | 4th | 5th | average |
| L1 | 382.7 | 356.8 | 402 | 360.2 | 354.8 | 370.94 |
| L2 | 365.9 | 397.5 | 348.4 | 350.5 | 342.2 | 360.9 |
| L3 | 345.8 | 385.6 | 397 | 339.9 | 354.8 | 364.62 |
| S1 | 354.8 | 368.1 | 351.2 | 345.2 | 330.2 | 349.9 |
| S2 | 320.2 | 337.7 | 340.5 | 358.3 | 342.2 | 339.76 |

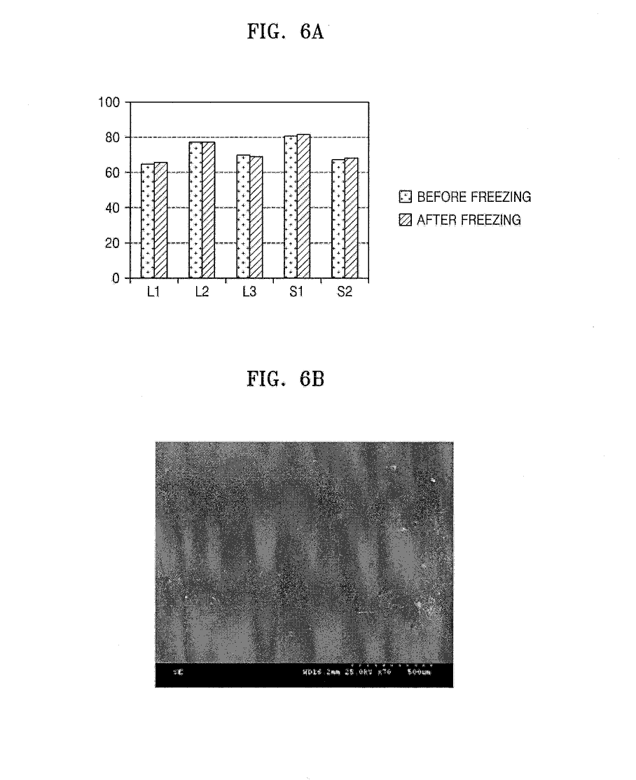

Hardness of the teeth low-speed thawed after the low-speed freezing is barely changed. In addition, a color change comparison graph shown in FIG. 6A shows that a color change barely occurs. In addition, referring to FIG. 6B showing an electron microscope picture, the tooth low-speed thawed after the low-speed freezing has the least change in comparison with the control group.

As a result, problems of thawing according to freezing are considered by considering physical characteristics of the hard tissues, and change aspects in relation to thawing are important. The low-speed thawing and low-speed freezing method according to an embodiment of the present invention barely damages hard tissue of a tooth and barely changes the color of the tooth in comparison with the tooth before freezing. Thus, when discarded autogeneous teeth are used through autogeneous tooth transplantation, a useful result in terms of storing and reusing teeth is provided.

According to another embodiment of the present invention, a process of manufacturing an artificial prosthesis is described.

First, wax is put on a plaster model of a patient' tooth. A model is made with an antagonist. The plaster model is imprinted. A new model is made by injecting heat-resistant plaster. An artificial tooth shape is made with wax in the new plaster model. A frame of the artificial tooth is produced with a Ticonium metal by melting the wax. The metal frame is polished. The metal frame is fit to the plaster model. A space to implant a tooth is prepared by using wax. A natural tooth of the patient, which was extracted when he or she was young and has been stored in a freezer, is implanted. If it fits the patient well, the wax is replaced with a resin.

According to a low-speed freezing and low speed thawing method according to an embodiment of the present invention, hard tissue of a tooth is bare damaged, and there is barely any change in a color of the tooth when compared to the tooth before freezing. Thus, the low-speed freezing and low speed thawing method provides a useful result in terms of storing and reusing teeth when discarded autogeneous teeth are used through autogeneous tooth transplantation.

In addition, the low-speed freezing and low speed thawing method may be useful in the manufacturing of an artificial prosthesis including an artificial tooth by using discarded teeth.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of storing and reusing hard tissue of a tooth, the method comprising:
low-speed freezing and storing the hard tissue of the tooth;
low-speed thawing the frozen hard tissue when the stored hard tissue is to be reused; and
reusing the hard tissue.

2. The method of claim 1, wherein the low-speed thawing comprises:
thawing the frozen hard tissue in a cold room; and
thawing the thawed hard tissue at room temperature again.

3. The method of claim 1, wherein the low-speed thawing comprises:
thawing the frozen hard tissue in a cold room at 2° C. to 3° C.; and
thawing the thawed hard tissue at room temperature again.

4. The method of claim 2, wherein the low-speed freezing comprises:
keeping the hard tissue cold; and
keeping the hard tissue frozen.

5. The method of claim 2, wherein the low-speed freezing comprises:
keeping the hard tissue cold at 2° C. to 3° C.; and
keeping the hard tissue frozen at −6° C. to −7° C.

6. The method of claim 3, wherein the low-speed freezing comprises:
keeping the hard tissue cold at 2° C. to 3° C.; and
keeping the hard tissue frozen at −6° C. to −7° C.

7. The method of claim 1, wherein the reusing comprises inserting the low-speed thawed hard tissue of the tooth into an insertion space prepared in an artificial prosthesis including an artificial tooth.

8. The method of claim 2, wherein the reusing comprises inserting the low-speed thawed hard tissue of the tooth into an insertion space prepared in an artificial prosthesis including an artificial tooth.

9. The method of claim 3, wherein the reusing comprises inserting the low-speed thawed hard tissue of the tooth into an insertion space prepared in an artificial prosthesis including an artificial tooth.

10. The method of claim 4, wherein the reusing comprises inserting the low-speed thawed hard tissue of the tooth into an insertion space prepared in an artificial prosthesis including an artificial tooth.

11. The method of claim 5, wherein the reusing comprises inserting the low-speed thawed hard tissue of the tooth into an insertion space prepared in an artificial prosthesis including an artificial tooth.

12. The method of claim 6, wherein the reusing comprises inserting the low-speed thawed hard tissue of the tooth into an insertion space prepared in an artificial prosthesis including an artificial tooth.
